(19) United States
(12) Patent Application Publication
(10) Pub. No.: US 2013/0247269 A1
(43) Pub. Date: Sep. 26, 2013

(54) SWIM CAP FOR A PERSON HAVING DREADLOCKS AND THE LIKE AND METHOD OF MAKING

(71) Applicant: Marceline Alburg, Brooklyn, NY (US)

(72) Inventor: Marceline Alburg, Brooklyn, NY (US)

(21) Appl. No.: 13/426,196

(22) Filed: Mar. 21, 2012

(51) Int. Cl. A42B 1/12; B31D 5/00; A42B 1/04

(52) U.S. Cl. 2/68; 2/202; 493/374

(57) ABSTRACT

A decorative swim/bath/shower tuque worn by a swimmer/bather/showerer, respectively, having voluminous hair with a length. The decorative swim/bath/shower tuque has dual lengths so as to adjust to the length of the voluminous hair of the swimmer/bather/showerer. The decorative swim/bath/shower tuque includes a sleeve, a dome, and a folded brim. The sleeve has a lower end and an upper end, and is worn by the swimmer/bather/showerer. The dome closes the upper end of the sleeve. The folded brim defines the lower end of the sleeve, and has the dual lengths so as to adjust the sleeve to the length of the voluminous hair of the swimmer/bather/showerer.

### 1. BACKGROUND OF THE INVENTION

A. Field of the Invention

The embodiments of the present invention relate to a hair cap, and more particularly, the embodiments of the present invention relate to a decorative swim/bath/shower tuque for wearing by a swimmer/bather/showerer, respectively, having voluminous hair with a length and having dual lengths so as to adjust to the length of the voluminous hair of the swimmer/bather/showerer and a method of making the decorative swim/bath/shower tuque.

B. Description of the Prior Art

Numerous innovations for hair-protecting caps have been provided in the prior art, which will be described below in chronological order to show advancement in the art, and which are incorporated herein by reference thereto. Even though these innovations may be suitable for the specific individual purposes to which they address, nevertheless, they differ from the present invention in that they do not teach a decorative swim/bath/shower tuque for wearing by a swimmer/bather/showerer, respectively, having voluminous hair with a length and having dual lengths so as to adjust to the length of the voluminous hair of the swimmer/bather/showerer and a method of making the decorative swim/bath/shower tuque.

### (1) U.S. Pat. No. 2,730,720 to Saunders

U.S. Pat. No. 2,730,720—issued to Saunders on Jan. 17, 1956 in U.S. class 2 and subclass 68—teaches a bathing and shower cap including a crown section to completely cover arrangeable hair of a head. The lower edge of the crown section defines an opening, and has its forward portion concavely formed to provide a front forehead and temple covering section. Side portions are convexly curved to form ear coverings and side sections. The rear portion of the crown portion is substantially straight to define a rear neck covering section, is formed of thin sheet plastic, and is adapted to conform itself to the contours of the wearer's head. The inside margin of the cap lies within, and above, the edge of the cap, and is provided with a pressure-sensitive adhesive material extending continuously around the inside margin. A flexible covering for the adhesive material has a free end portion adapted to be grasped whereby the covering can be stripped from the adhesive.

### (2) U.S. Pat. No. 3,750,681 to Claunch

U.S. Pat. No. 3,750,681—issued to Claunch on Aug. 7, 1973 in U.S. class 132 and subclass 274—teaches a hair protector having a first portion for covering the hair and a second portion adapted to fit tightly across the forehead and the sides of the face to secure the hair protector in place on the head. The second portion includes a band of stretch knit material having a smooth surface for engaging and extending across the forehead without forming creases therein, yet the band holds the protector from slipping downwardly and forwardly across the face during use. Several embodiments of the hair protector include a shower cap adapted for use with a bouffant hairdo.

### (3) U.S. Pat. No. 5,249,308 to Blume

U.S. Pat. No. 5,249,308—issued to Blume on Oct. 5, 1993 in U.S. class 2 and subclass 174—teaches an after shower hat fabricated from a towel-like material. A rectangular piece of the material is folded in half. The open sides are sewn forming first and second seams, and elastic is sewn around the opening to provide a snug fit. The seams are also provided with a stiffening material, whereby when the hat is worn with the seams at the front and back of the head, the hat stands relatively straight out from the wearer's head. This permits the hair to dry without flattening.

### (4) U.S. Pat. No. 5,365,613 to Henegan

U.S. Pat. No. 5,365,613—issued to Henegan on Nov. 22, 1994 in U.S. class 2 and subclass 174—teaches a hair drying turban made from a single piece of absorbent cloth, and has a cap portion, and extending forwardly, a hair basket portion. In use, the wearer places the cap portion on his or her hair, with the hair extending forwardly over the forehead and face, and with the wearer bending at the waist. Then, with the hair placed neatly within the hair basket portion, the hair basket is twisted about the longitudinal axis of the hair. The hair basket portion is then folded backwardly along the center line of the cap portion and is secured to the back of the cap portion. A loop is provided for allowing the turban to be easily hung on a door peg and/or to facilitate the tucking in of the hair basket portion beneath the cap portion.

### (5) U.S. Pat. No. 5,890,229 to Esposito

U.S. Pat. No. 5,890,229—issued to Esposito on Apr. 6, 1999 in U.S. class 2 and subclass 174—teaches a hair pouch for being worn over wet hair. The pouch has an opening end with a resilient band and a baggy pouch including only a terry cloth-type material. When worn, the weight of the baggy portion causes the pouch to hang downward while resting against the wearer's hair causing the hair to flatten out. Wearing this hair pouch eliminates dripping after showers, and helps to keep hair dry while working or playing in hot and humid conditions. Furthermore, the pouch allows the wearer to apply makeup without having the wet hair drip. The hair pouch can be worn by person's with long hair, short hair, and by chemotherapy patients. The pouch can also be used as a steering wheel cover to protect the steering wheel from the effects of the sun while a vehicle is parked keeping the steering wheel cool so as not to burn a driver's hands.

### (6) U.S. Pat. No. 6,330,721 to Wallace et al

U.S. Pat. No. 6,330,721—issued to Wallace et al. on Dec. 18, 2001 in U.S. class 2 and subclass 174—teaches a shower cap including an elastic strap that is permanently attached to the elastic band located at lower edge of a shower cap. The elastic strap has fasteners on each end that allow it to form a loop and suspend from a shower curtain rod, towel rack, doorknob, or hook/nail in the wall. This suspension also allows the shower cap to thoroughly dry. The elastic strap permits convenient storage of the shower cap and that helps to eliminate the possibility of it being misplaced. The fasteners on each end of the elastic strap can be easily pulled apart and reattached because they are in the form of hook and loop fasteners.

### (7) U.S. Pat. No. 6,820,283 to Graneto, III

U.S. Pat. No. 6,820,283—issued to Graneto, III on Nov. 23, 2004 in U.S. class 2 and subclass 171.2—teaches a hair washing shower cap and method of manufacture, which includes a flexible exterior material laminated with an absorbent interior material and anon-rinse solution on the interior material. The device has an elastic periphery that is capable of elastically constricting about a user's head during use. The device further allows a user to massage the exterior material and easily transfer the massage through the interior material and onto a user's hair or scalp.

### (8) U.S. Pat. No. 6,918,138 to Donovan

U.S. Pat. No. 6,918,138—issued to Donovan on Jul. 19, 2005 in U.S. class 2 and subclass 174—teaches a liner for a shower cap, which has a chamber or ampoule containing a predetermined quantity of a supercooled liquid exotherm compound, and a small amount of the compound in the crystal form, so that the crystal and the liquid are separated until time for use. Upon action by the user, as by bending or otherwise breaking the separation between the crystal and the liquid, an exothermic reaction takes place as the liquid crystallizes releasing a known amount of heat to cause the towel to warm. Calcium carbonate is the preferred compound. A temperature indicator may also be included as part of the packaging. A hair cleaning compound is provided, such as a shampoo, hair conditioner, hair moisturizer, scalp conditioning agents, or mixtures.

### (9) United States Patent Application Publication Number 2006/0272073 to Marquardt

United States Patent Application Publication Number 2006/0272073—published to Marquardt on Dec. 7, 2006 in U.S. class 2 and subclass 171—teaches a modified head covering having a cap portion that resembles typical head caps, as well as a pouch portion attached to the rear of the cap. This head covering allows a user having long hair to safely conceal his or her hair within the pouch portion at the rear of the head covering. The pouch portion can be cinched tightly into a “sack” or “pouch” shape through the use of a ribbon, an elastic band, or other devices. Once the pouch portion is constricted, the hair is safely concealed and kept off of the nape of the neck. The head covering can be made of a variety of fabrics with a number of patterns or colors. The modified head covering is particularly suited to medical personnel working in sterile environments, but it is useful for anyone with long hair who must conceal his or her hair inside a cap.

It is apparent that numerous innovations for hair-protecting caps have been provided in the prior art, which are adapted to be used. Furthermore, even though these innovations may be suitable for the specific individual purposes to which they address, nevertheless, they would not be suitable for the purposes of the embodiments of the present invention as heretofore described, namely, a decorative swim/bath/shower tuque for wearing by a swimmer/bather/showerer, respectively, having voluminous hair with a length and having dual lengths so as to adjust to the length of the voluminous hair of the swimmer/bather/showerer and a method of making the decorative swim/bath/shower tuque.

### 2. SUMMARY OF THE INVENTION

Thus, an object of the embodiments of the present invention is to provide a decorative swim/bath/shower tuque for wearing by a swimmer/bather/showerer, respectively, having voluminous hair with a length and having dual lengths so as to adjust to the length of the voluminous hair of the swimmer/bather/showerer and a method of making the decorative swim/bath/shower tuque, which avoids the disadvantages of the prior art.

Briefly stated, another object of the embodiments of the present invention is to provide a decorative swim/bath/shower tuque worn by a swimmer/bather/showerer, respectively, having voluminous hair with a length. The decorative swim/bath/shower tuque has dual lengths so as to adjust to the length of the voluminous hair of the swimmer/bather/showerer. The decorative swim/bath/shower tuque includes a sleeve, a dome, and a folded brim. The sleeve has a lower end and an upper end, and is worn by the swimmer/bather/showerer. The dome closes the upper end of the sleeve. The folded brim defines the lower end of the sleeve, and has the dual lengths so as to adjust the sleeve to the length of the voluminous hair of the swimmer/bather/showerer.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### 3. BRIEF DESCRIPTION OF THE FIGURES OF THE DRAWING

The figures of the drawing are briefly described as follows:

FIG. 1 is a diagrammatic side elevational view of the decorative swim/bath/shower tuque of the embodiments of the present invention being worm by a swimmer/bather/showerer, respectively, having voluminous hair with a length and having dual lengths so as to adjust to the length of the voluminous hair of the swimmer/bather/showerer;

FIG. 2 is a diagrammatic front perspective view of the decorative swim/bath/shower tuque of the embodiments of the present invention identified by ARROW 2 in FIG. 1;

FIG. 3 is a diagrammatic rear perspective view of the decorative swim/bath/shower tuque of the embodiments of the present invention identified by ARROW 3 in FIG. 1;

FIG. 4 is a diagrammatic side perspective view of the decorative swim/bath/shower tuque of the embodiments of the present invention identified by ARROW 4 in FIG. 1;

FIG. 5 is an enlarged diagrammatic top plan view taken generally in the direction of ARROW 5 in FIGS. 2-4;

FIG. 6 is an enlarged diagrammatic bottom plan view taken generally in the direction of ARROW 6 in FIGS. 2-4;

FIG. 7 is an enlarged diagrammatic cross sectional view taken along LINE 7-7 in FIGS. 2-4 of a first embodiment of the folded brim of the decorative swim/bath/shower tuque of the embodiments of the present invention in its long state;

FIG. 8 is an enlarged diagrammatic cross sectional view taken along LINE 8-8 in FIGS. 2-4 of a second embodiment of the folded brim of the decorative swim/bath/shower tuque of the embodiments of the present invention in its long state;

FIG. 9 is an enlarged diagrammatic cross sectional view taken along LINE 9-9 in FIGS. 2-4 of the first embodiment of the folded brim of the decorative swim/bath/shower tuque of the embodiments of the present invention shown in FIG. 7 in its short state;

FIG. 10 is an enlarged diagrammatic cross sectional view taken along LINE 10-10 in FIGS. 2-4 of the second embodiment of the folded brim of the decorative swim/bath/shower tuque of the embodiments of the present invention shown in FIG. 8 in its short state;

FIG. 11 is an enlarged diagrammatic cross sectional view taken along LINE 11-11 in FIGS. 2-4 of a first embodiment of the dome of the decorative swim/bath/shower tuque of the embodiments of the present invention;

FIG. 12 is an enlarged diagrammatic cross sectional view taken along LINE 12-12 in FIGS. 2-4 of a second embodiment of the dome of the decorative swim/bath/shower tuque of the embodiments of the present invention; and

FIGS. 13A-13C is a diagrammatic flow chart of the method of making the decorative swim/bath/shower tuque of the embodiments of the present invention.

### 4. LIST OF REFERENCE NUMERALS UTILIZED IN THE FIGURES OF THE DRAWING

A. General.
20 decorative swim/bath/shower tuque of embodiments of present invention for wearing by swimmer/bather/showerer 22, respectively, having voluminous hair 24 with length 26 and having dual lengths so as to adjust to length 26 of voluminous hair 24 of swimmer/bather/showerer 22
22 swimmer/bather/showerer
24 voluminous hair of swimmer/bather/showerer 22
26 length of voluminous hair 24 of swimmer/bather/showerer 22

B. Overall Configuration of Decorative Swim/Bath/Shower Tuque 20.
28 sleeve for wearing by swimmer/bather/showerer 22
30 dome
32 folded brim
34 lower end of sleeve 28
36 upper end of sleeve 28

C. Specific Configuration of Sleeve 28.
38 water-proof, water-repellent, and thin sheet plastic/vinyl sleeve of sleeve 28
40 generally circular flange of upper end 36 of water-proof, water-repellent, and thin sheet plastic/vinyl sleeve 38 of sleeve 28

D. Specific Configuration of Dome 30.
42 generally inverted cup-shaped dome of dome 30
43 water-proof, water-repellent, and thin sheet plastic/vinyl dome of generally inverted cup-shaped dome 42 of dome 30
44 generally disk-shaped base of water-proof, water-repellent, and thin sheet plastic/vinyl dome 43 of generally inverted cup-shaped dome 42 of dome 30
46 generally circular peripheral flange of water-proof, water-repellent, and thin sheet plastic/vinyl dome 43 of generally inverted cup-shaped dome 42 of dome 30
48 heated seam of water-proof, water-repellent, and thin sheet plastic/vinyl dome 43 of generally inverted cup-shaped dome 42 of dome 30
49 waterproof attachment of water-proof, water-repellent, and thin sheet plastic/vinyl dome 43 of generally inverted cup-shaped dome 42 of dome 30
50 stitched seam of water-proof, water-repellent, and thin sheet plastic/vinyl dome 43 of generally inverted cup-shaped dome 42 of dome 30
51 waterproof attachment of water-proof, water-repellent, and thin sheet plastic/vinyl dome 43 of generally inverted cup-shaped dome 42 of dome 30

E. Specific Configuration of Folded Brim 32.
52 seams of folded brim 32 of lower end 34 of water-proof, water-repellent, and thin sheet plastic/vinyl sleeve 38 of sleeve 28
54 heated seams of seams 52 of folded brim 32 of lower end 34 of water-proof, water-repellent, and thin sheet plastic/vinyl sleeve 38 of sleeve 28
56 stitched seams of seams 52 of folded brim 32 of lower end 34 of water-proof, water-repellent, and thin sheet plastic/vinyl sleeve 38 of sleeve 28
58 drawstring of folded brim 32

### 5. DETAILED DESCRIPTION OF THE PREFERRED EMBODIMENTS

### A. General

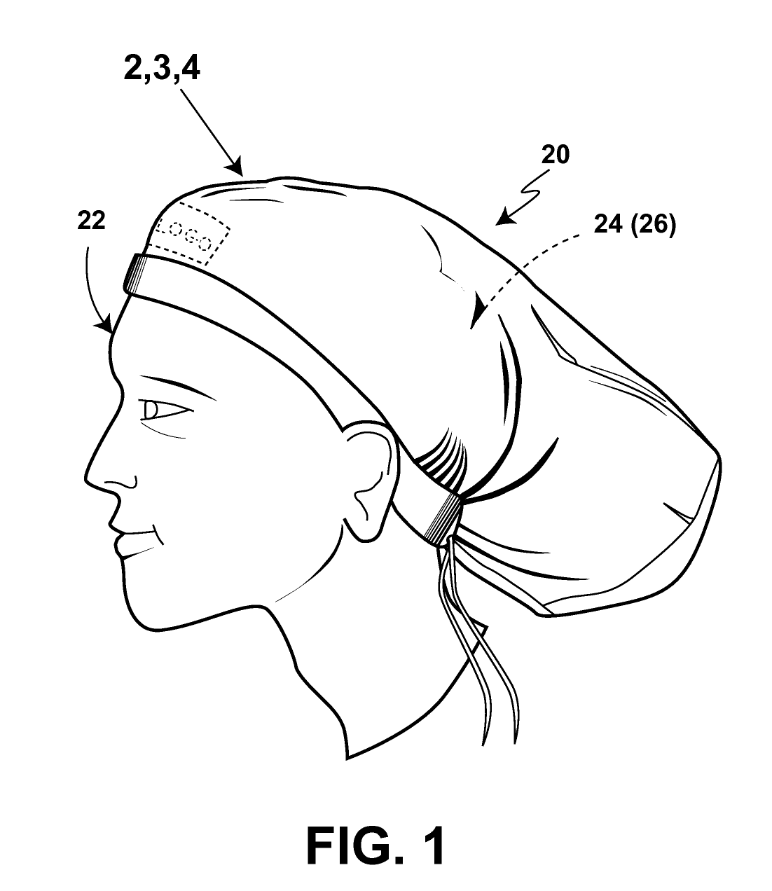

Referring now to the figures, in which like numerals indicate like parts, and particularly to FIG. 1, which is a diagrammatic side elevational view of the decorative swim/bath/shower tuque of the embodiments of the present invention being worm by a swimmer/bather/showerer, respectively, having voluminous hair with a length and having dual lengths so as to adjust to the length of the voluminous hair of the swimmer/bather/showerer, the decorative swim/bath/shower tuque of the embodiments of the present invention is shown generally at 20 for wearing by a swimmer/bather/showerer 22, respectively, having voluminous hair 24 with a length 26 and having dual lengths so as to adjust to the length 26 of the voluminous hair 24 of the swimmer/bather/showerer 22.

### B. Overall Configuration of the Decorative Swim/Bath/Shower Tuque 20

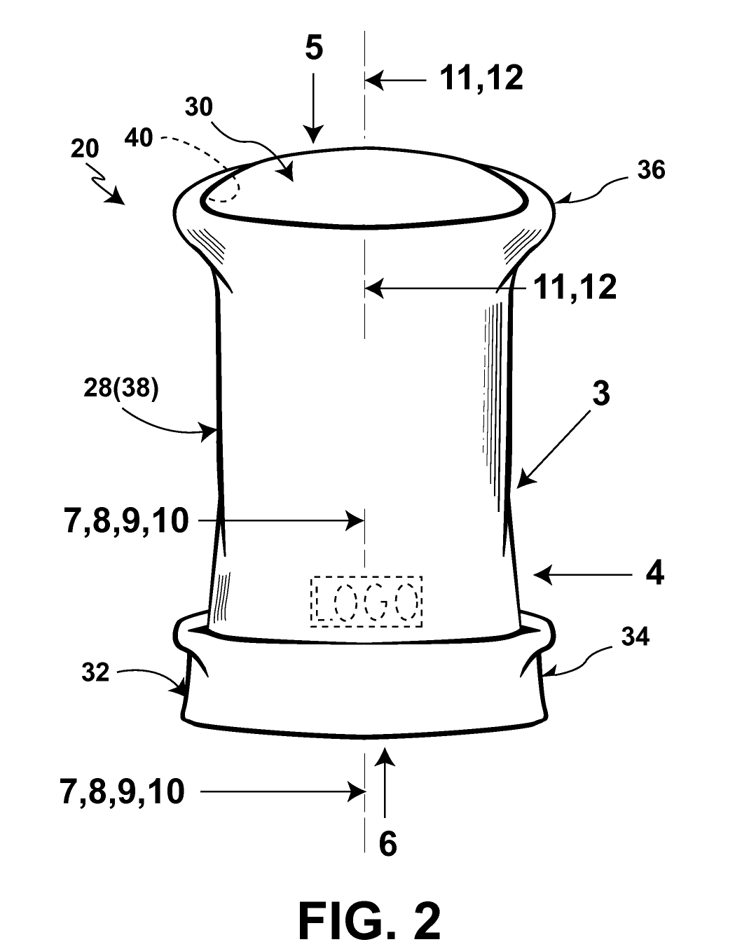

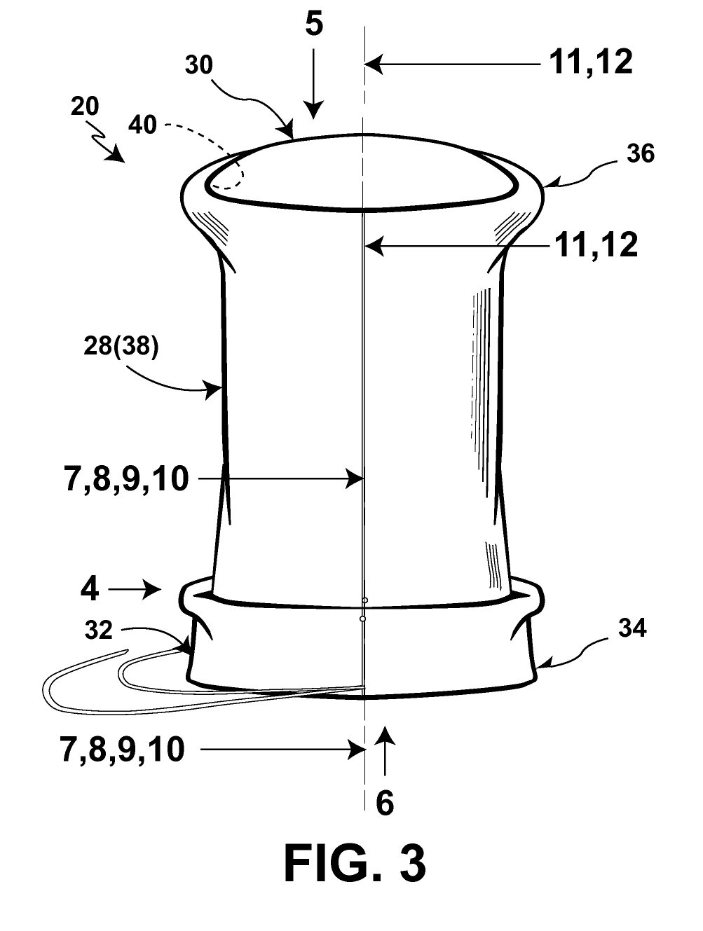

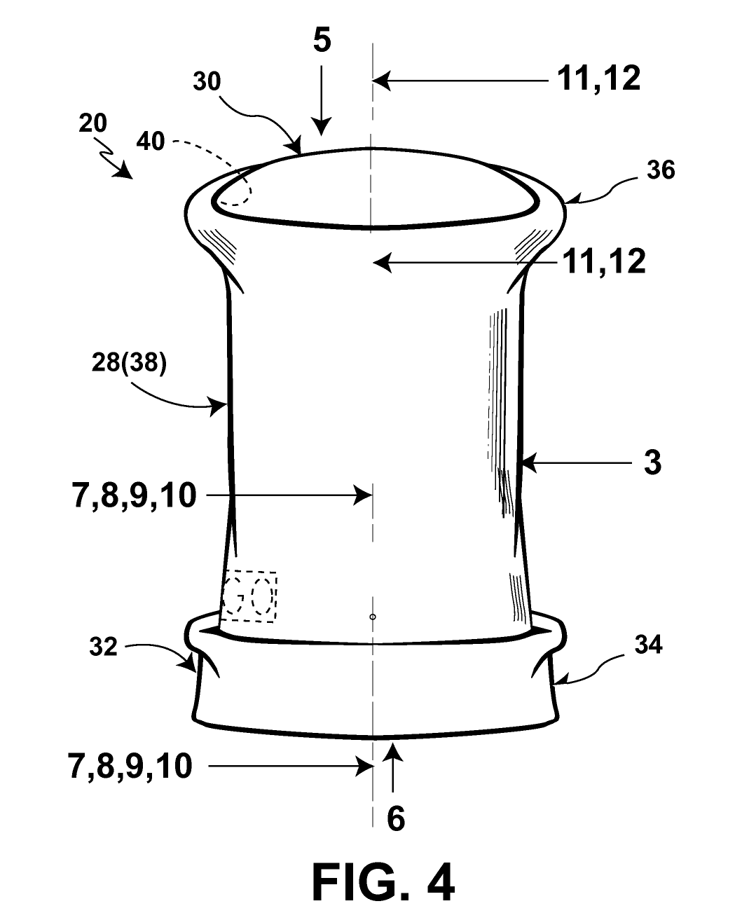

The overall configuration of the decorative swim/bath/shower tuque 20 can best be seen in FIGS. 2-4, which are, respectively, a diagrammatic front perspective view of the decorative swim/bath/shower tuque of the embodiments of the present invention identified by ARROW 2 in FIG. 1, a diagrammatic rear perspective view of the decorative swim/bath/shower tuque of the embodiments of the present invention identified by ARROW 3 in FIG. 1, and a diagrammatic side perspective view of the decorative swim/bath/shower tuque of the embodiments of the present invention identified by ARROW 4 in FIG. 1, and as such, will be discussed with reference thereto.

The decorative swim/bath/shower tuque 20 comprises a sleeve 28, a dome 30, and a folded brim 32.

The sleeve 28 has a lower end 34 and an upper end 36, and is for wearing by the swimmer/bather/showerer 22, respectively.

The dome 30 closes the upper end 36 of the sleeve 28.

The folded brim 32 defines the lower end 34 of the sleeve 28, and has the dual lengths so as to adjust the sleeve 28 to the length 26 of the voluminous hair 24 of the swimmer/bather/showerer 22.

### C. Specific Configuration of the Sleeve 28

The specific configuration of the sleeve 28 can best be seen in FIGS. 2-4, which are again, respectively, a diagrammatic front perspective view of the decorative swim/bath/shower tuque of the embodiments of the present invention identified by ARROW 2 in FIG. 1, a diagrammatic rear perspective view of the decorative swim/bath/shower tuque of the embodiments of the present invention identified by ARROW 3 in FIG. 1, and a diagrammatic side perspective view of the decorative swim/bath/shower tuque of the embodiments of the present invention identified by ARROW 4 in FIG. 1, and as such, will be discussed with reference thereto.

The sleeve 28 is a water-proof, water-repellent, and thin sheet plastic/vinyl sleeve 38 having a generally circular lateral cross section. The lower end 34 of the water-proof, water-repellent, and thin sheet plastic/vinyl sleeve 38 of the sleeve 28 is open and foldable. The upper end 36 of the water-proof, water-repellent, and thin sheet plastic/vinyl sleeve 38 of the sleeve 28 is open, and folded inward to form a generally circular flange 40.

### D. Specific Configuration of the Dome 30

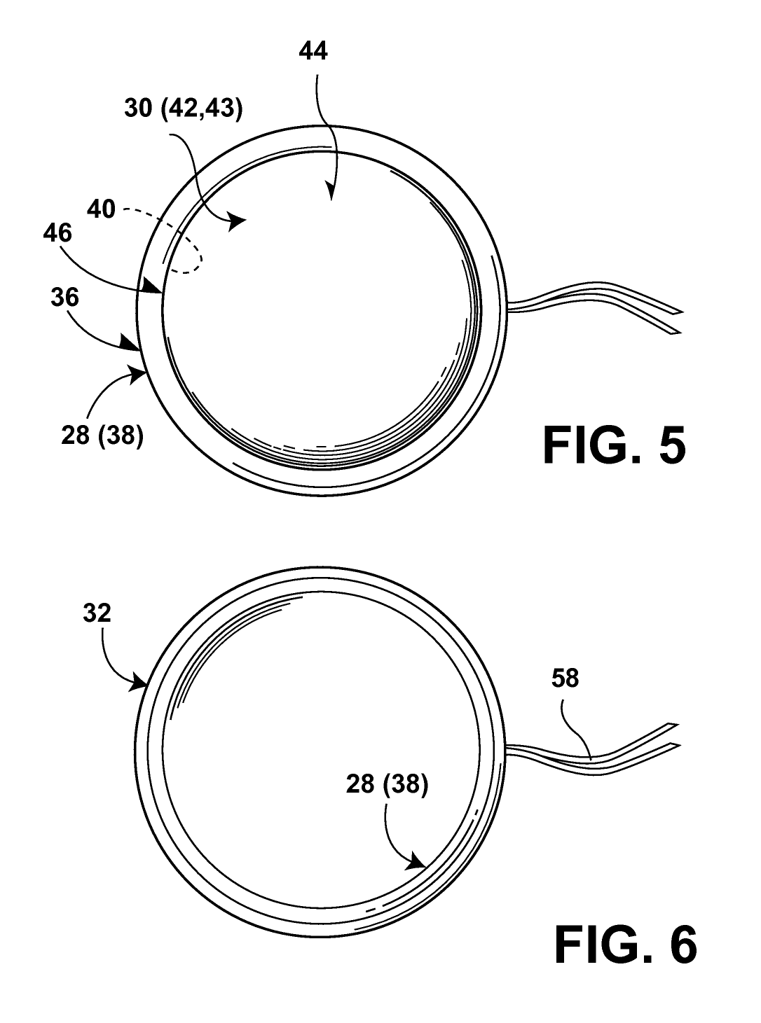

The specific configuration of the dome 30 can best be seen in FIGS. 5, 11, and 12, which are, respectively, an enlarged diagrammatic top plan view taken generally in the direction of ARROW 5 in FIGS. 2-4, an enlarged diagrammatic cross sectional view taken along LINE 11-11 in FIGS. 2-4 of a first embodiment of the dome of the decorative swim/bath/shower tuque of the embodiments of the present invention, and an enlarged diagrammatic cross sectional view taken along LINE 12-12 in FIGS. 2-4 of a second embodiment of the dome of the decorative swim/bath/shower tuque of the embodiments of the present invention, and as such, will be discussed with reference thereto.

The dome 30 is a generally inverted cup-shaped dome 42. The generally inverted cup-shaped dome 42 of the dome 30 is a water-proof, water-repellent, and thin sheet plastic/vinyl dome 43 having a generally disk-shaped base 44 and a generally circular peripheral flange 46. The generally circular peripheral flange 46 of the water-proof, water-repellent, and thin sheet plastic/vinyl dome 43 of the generally inverted cup-shaped dome 42 of the dome 30 depends from the generally disk-shaped base 44 of the water-proof, water-repellent, and thin sheet plastic/vinyl dome 43 of the generally inverted cup-shaped dome 42 of the dome 30.

The water-proof, water-repellent, and thin sheet plastic/vinyl dome 43 of the generally inverted cup-shaped dome 42 of the dome 30 sits in and closes the upper end 36 of the water-proof, water-repellent, and thin sheet plastic/vinyl sleeve 38 of the sleeve 28, with the generally circular peripheral flange 46 of the water-proof, water-repellent, and thin sheet plastic/vinyl dome 43 of the generally inverted cup-shaped dome 42 of the dome 30 inwardly and intimately adjacent to the generally circular flange 40 of the upper end 36 of the water-proof, water-repellent, and thin sheet plastic/vinyl sleeve 38 of the sleeve 28.

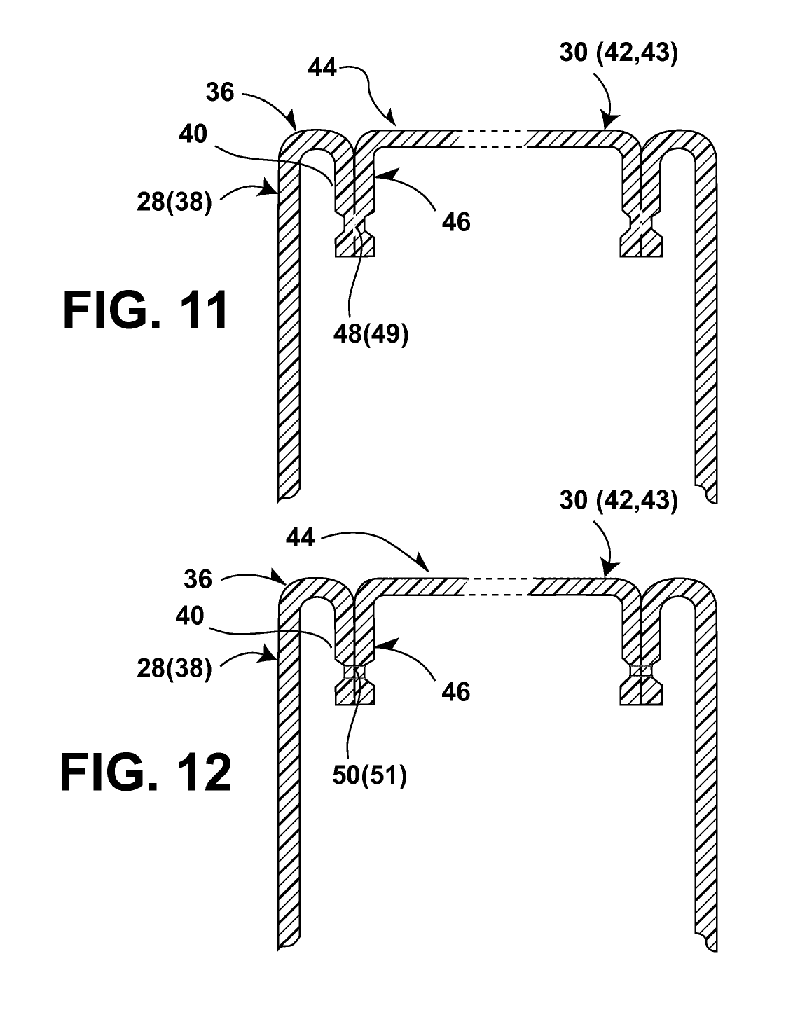

As shown in FIG. 11, the water-proof, water-repellent, and thin sheet plastic/vinyl dome 43 of the generally inverted cup-shaped dome 42 of the dome 30 further has a heated seam 48. The heated seam 48 of the water-proof, water-repellent, and thin sheet plastic/vinyl dome 43 of the generally inverted cup-shaped dome 42 of the dome 30 maintains the generally circular peripheral flange 46 of the water-proof, water-repellent, and thin sheet plastic/vinyl dome 43 of the generally inverted cup-shaped dome 42 of the dome 30 affixed to the generally circular flange 40 of the upper end 36 of the water-proof, water-repellent, and thin sheet plastic/vinyl sleeve 38 of the sleeve 28 so as to form a waterproof attachment 49.

As shown in FIG. 12, the water-proof, water-repellent, and thin sheet plastic/vinyl dome 43 of the generally inverted cup-shaped dome 42 of the dome 30 further has a stitched seam 50. The stitched seam 50 of the water-proof, water-repellent, and thin sheet plastic/vinyl dome 43 of the generally inverted cup-shaped dome 42 of the dome 30 maintains the generally circular peripheral flange 46 of the water-proof, water-repellent, and thin sheet plastic/vinyl dome 43 of the generally inverted cup-shaped dome 42 of the dome 30 affixed to the generally circular flange 40 of the upper end 36 of the water-proof, water-repellent, and thin sheet plastic/vinyl sleeve 38 of the sleeve 28 so as to form a waterproof attachment 51.

### E. Specific Configuration of the Folded Brim 32

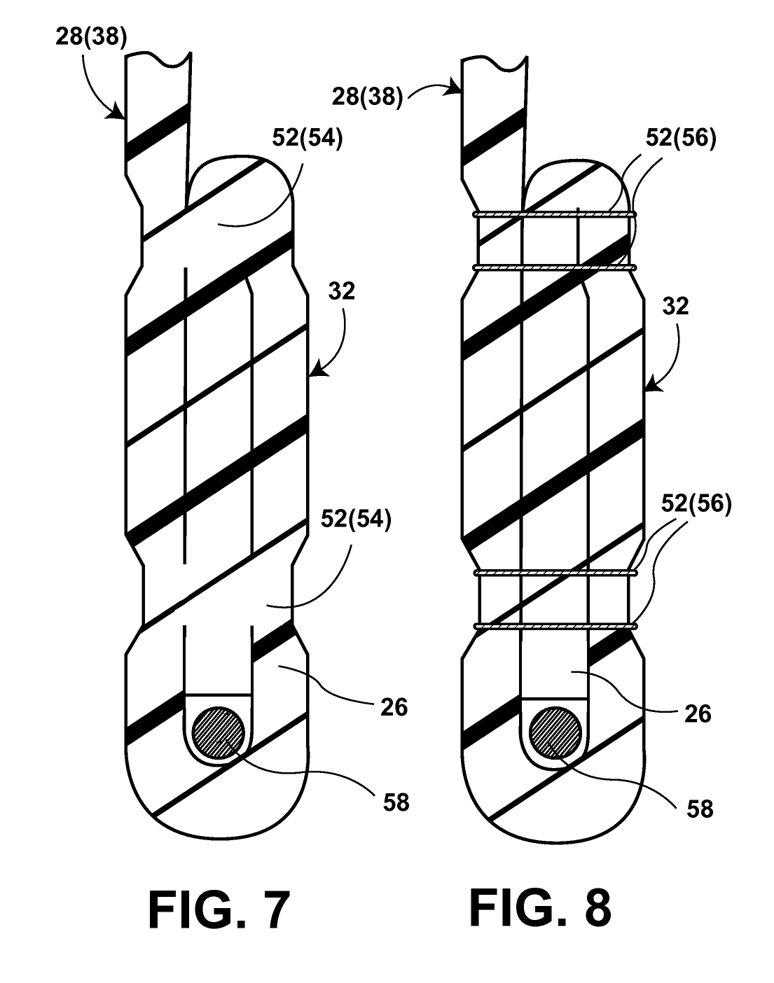

The specific configuration of the folded brim 32 can best be seen in FIGS. 6-10, which are, respectively, an enlarged diagrammatic bottom plan view taken generally in the direction of ARROW 6 in FIGS. 2-4, an enlarged diagrammatic cross sectional view taken along LINE 7-7 in FIGS. 2-4 of a first embodiment of the folded brim of the decorative swim/bath/shower tuque of the embodiments of the present invention in its long state, an enlarged diagrammatic cross sectional view taken along LINE 8-8 in FIGS. 2-4 of a second embodiment of the folded brim of the decorative swim/bath/shower tuque of the embodiments of the present invention in its long state, an enlarged diagrammatic cross sectional view taken along LINE 9-9 in FIGS. 2-4 of the first embodiment of the folded brim of the decorative swim/bath/shower tuque of the embodiments of the present invention shown in FIG. 7 in its short state, and an enlarged diagrammatic cross sectional view taken along LINE 10-10 in FIGS. 2-4 of the second embodiment of the folded brim of the decorative swim/bath/shower tuque of the embodiments of the present invention shown in FIG. 8 in its short state, and as such, will be discussed with reference thereto.

The folded brim 32 comprises the lower end 34 of the water-proof, water-repellent, and thin sheet plastic/vinyl sleeve 38 of the sleeve 28 folded up outwardly onto itself, and is maintained thereat by seams 52.

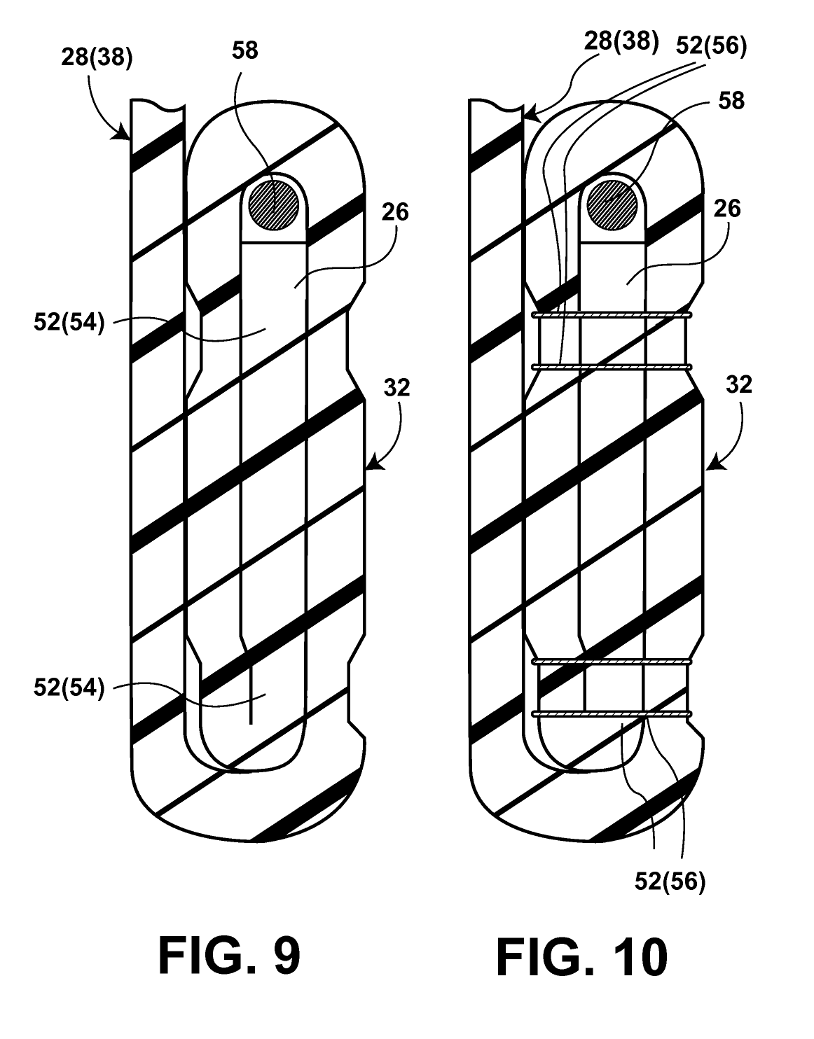

As shown in FIGS. 7 and 9, the seams 52 of the folded brim 32 of the lower end 34 of the water-proof, water-repellent, and thin sheet plastic/vinyl sleeve 38 of the sleeve 28 are heated seams 54.

As shown in FIGS. 8 and 10, the seams 52 of the folded brim 32 of the lower end 34 of the water-proof, water-repellent, and thin sheet plastic/vinyl sleeve 38 of the sleeve 28 are stitched seams 56.

As shown in FIGS. 7 and 8, the lower end 34 of the water-proof, water-repellent, and thin sheet plastic/vinyl sleeve 38 of the sleeve 28 is folded up outwardly onto itself twice times so as to allow the decorative swim/bath/shower tuque 20 to be in a long state, while, as shown in FIGS. 9 and 10, the lower end 34 of the water-proof, water-repellent, and thin sheet plastic/vinyl sleeve 38 of the sleeve 28 is folded up outwardly onto itself thrice times so as to allow the decorative swim/bath/shower tuque 20 to be in a short state, to thereby allow the sleeve 28 to have the dual lengths so as to adjust the sleeve 28 to the length 26 of the voluminous hair 24 of the swimmer/bather/showerer 22.

The folded brim 32 further comprises a drawstring 58. The drawstring 58 of the folded brim 32 extends along through the lower end 34 of the water-proof, water-repellent, and thin sheet plastic/vinyl sleeve 38 of the sleeve 28, and is pulled taunt after the decorative swim/bath/shower tuque 20 has been donned to thereby replaceably maintain the decorative swim/bath/shower tuque 20 in place on the swimmer/bather/showerer 22.

### F. Method of Making the Decorative Swim/Bath/Shower Tuque 20

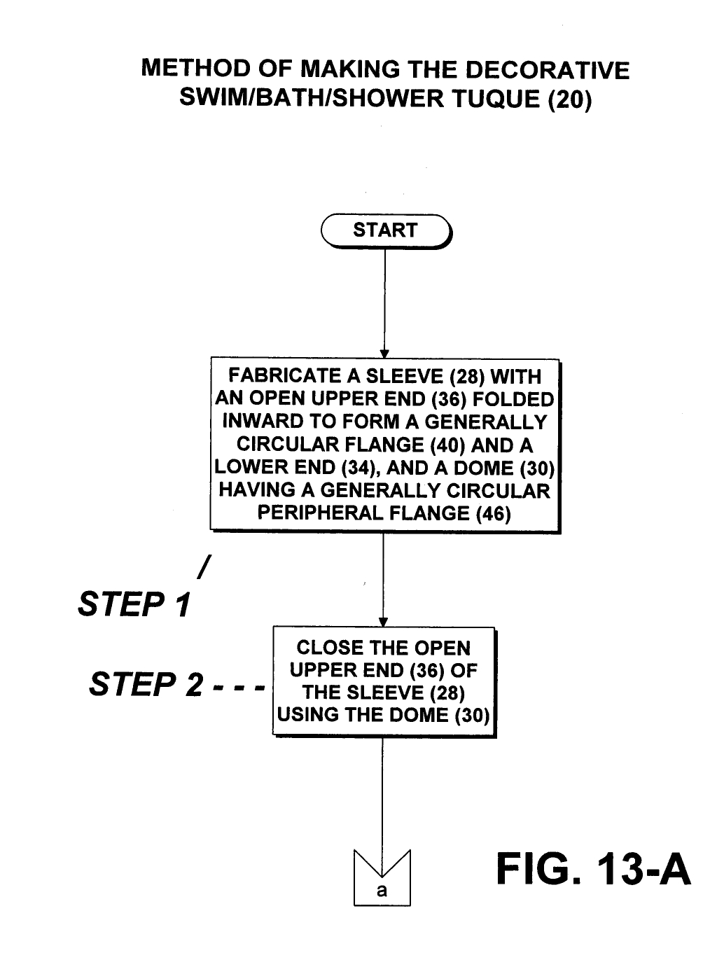

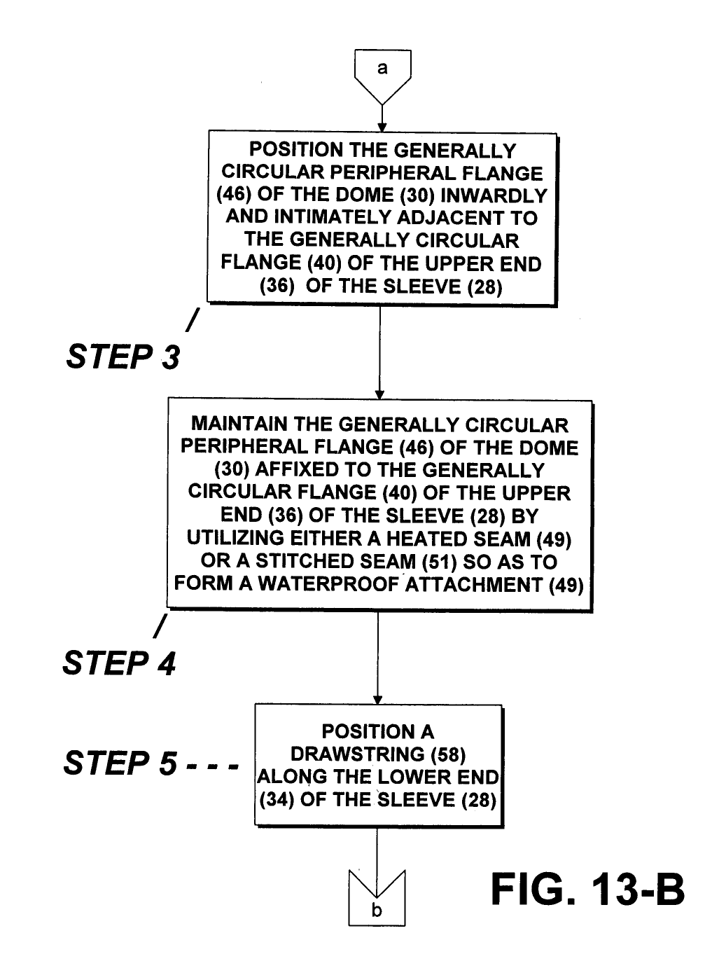

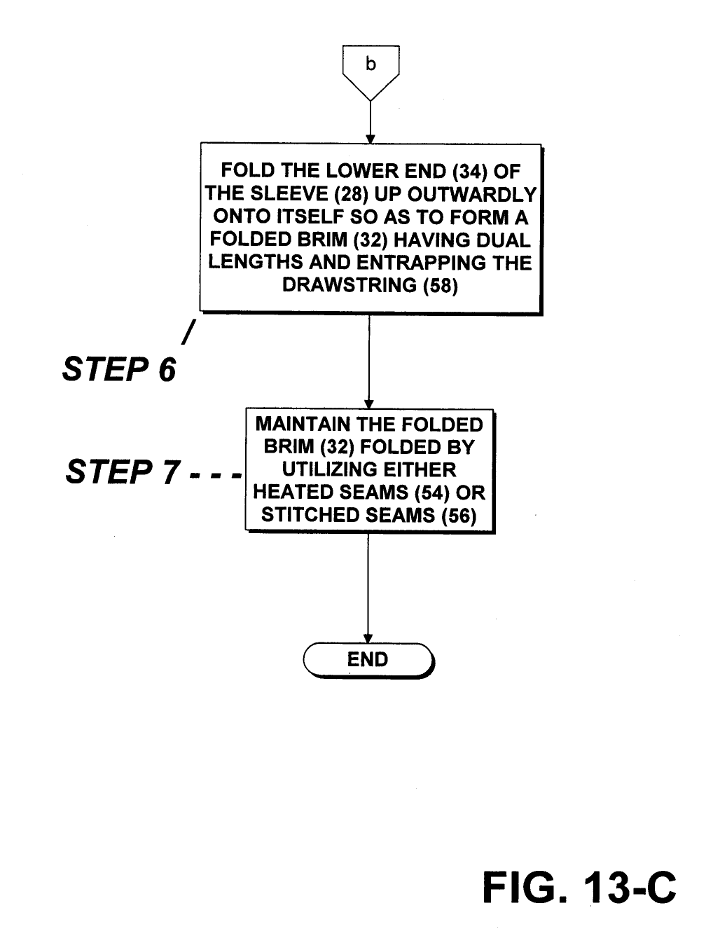

The method of making the decorative swim/bath/shower tuque 20 can best be seen in FIGS. 13A-13C, which are, a diagrammatic flow chart of the method of making the decorative swim/bath/shower tuque of the embodiments of the present invention, and as such, will be discussed with reference thereto.

The method of making the decorative swim/bath/shower tuque 20 comprises the steps of:
STEP 1: Fabricate a sleeve 28 with an open upper end 36 folded inward to form a generally circular flange 40 and a lower end 34, and a dome 30 having a generally circular peripheral flange 46.
STEP 2: Close the open upper end 36 of the sleeve 28 using the dome 30.
STEP 3: Position the generally circular peripheral flange 46 of the dome 30 inwardly and intimately adjacent to the generally circular flange 40 of the upper end 36 of the sleeve 28.
STEP 4: Maintain the generally circular peripheral flange 46 of the dome 30 affixed to the generally circular flange 40 of the upper end 36 of the sleeve 28 by utilizing either a heated seam 49 or a stitched seam 51 so as to form a waterproof attachment 49.
STEP 5: Position a drawstring 58 along the lower end 34 of the sleeve 28.
STEP 6: Fold the lower end 34 of the sleeve 28 up outwardly onto itself so as to form a folded brim 32 having dual lengths and entrapping the drawstring 58.
STEP 7: Maintain the folded brim 32 folded by utilizing either heated seams 54 or stitched seams 56.

### G. Impressions

It will be understood that each of the elements described above or two or more together may also find a useful application in other types of constructions differing from the types described above.

While the embodiments of the present invention have been illustrated and described as embodied in a decorative swim/bath/shower tuque for wearing by a swimmer/bather/showerer, respectively, having voluminous hair with a length and having dual lengths so as to adjust to the length of the voluminous hair of the swimmer/bather/showerer and a method of making the decorative swim/bath/shower tuque, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A decorative swim/bath/shower tuque for wearing by a swimmer/bather/showerer, respectively, having voluminous hair with a length, wherein said decorative swim/bath/shower tuque has dual lengths so as to adjust to the length of the voluminous hair of the swimmer/bather/showerer, said decorative swim/bath/shower tuque comprising:
a) a sleeve;
b) a dome; and
c) a folded brim;
wherein said sleeve has a lower end;
wherein said sleeve has an upper end;
wherein said sleeve is for wearing by the swimmer/bather/showerer;
wherein said dome closes said upper end of said sleeve;
wherein said folded brim defines said lower end of said sleeve; and
wherein said folded brim has said dual lengths so as to adjust said sleeve to the length of the voluminous hair of the swimmer/bather/showerer.

2. The tuque of claim 1, wherein said sleeve is a water-proof, water-repellent, and thin sheet plastic/vinyl sleeve.

3. The tuque of claim 2, wherein said water-proof, water-repellent, and thin sheet plastic/vinyl sleeve of said sleeve has a generally circular lateral cross section.

4. The tuque of claim 2, wherein said lower end of said water-proof, water-repellent, and thin sheet plastic/vinyl sleeve of said sleeve is open.

5. The tuque of claim 2, wherein said lower end of said water-proof, water-repellent, and thin sheet plastic/vinyl sleeve of said sleeve is foldable.

6. The tuque of claim 2, wherein said upper end of said water-proof, water-repellent, and thin sheet plastic/vinyl sleeve of said sleeve is open.

7. The tuque of claim 2, wherein said upper end of said water-proof, water-repellent, and thin sheet plastic/vinyl sleeve of said sleeve is folded inward to form a generally circular flange.

8. The tuque of claim 7, wherein said dome is a generally inverted cup-shaped dome.

9. The tuque of claim 8, wherein said generally inverted cup-shaped dome of said dome is a water-proof, water-repellent, and thin sheet plastic/vinyl dome.

10. The tuque of claim 9, wherein said water-proof, water-repellent, and thin sheet plastic/vinyl dome of said generally inverted cup-shaped dome of said dome has:
a) a generally disk-shaped base; and
b) a generally circular peripheral flange.

11. The tuque of claim 10, wherein said generally circular peripheral flange of said water-proof, water-repellent, and thin sheet plastic/vinyl dome of said generally inverted cup-shaped dome of said dome depends from said generally disk-shaped base of said water-proof, water-repellent, and thin sheet plastic/vinyl dome of said generally inverted cup-shaped dome of said dome.

12. The tuque of claim 9, wherein said water-proof, water-repellent, and thin sheet plastic/vinyl dome of said generally inverted cup-shaped dome of said dome sits in and closes said upper end of said water-proof, water-repellent, and thin sheet plastic/vinyl sleeve of said sleeve; and
wherein said generally circular peripheral flange of said water-proof, water-repellent, and thin sheet plastic/vinyl dome of said generally inverted cup-shaped dome of said dome is inwardly and intimately adjacent to said generally circular flange of said upper end of said water-proof, water-repellent, and thin sheet plastic/vinyl sleeve of said sleeve.

13. The tuque of claim 10, wherein said water-proof, water-repellent, and thin sheet plastic/vinyl dome of said generally inverted cup-shaped dome of said dome has a heated seam.

14. The tuque of claim 13, wherein said heated seam of said water-proof, water-repellent, and thin sheet plastic/vinyl dome of said generally inverted cup-shaped dome of said dome maintains said generally circular peripheral flange of said water-proof, water-repellent, and thin sheet plastic/vinyl dome of said generally inverted cup-shaped dome of said dome affixed to said generally circular flange of said upper end of said water-proof, water-repellent, and thin sheet plastic/vinyl sleeve of said sleeve so as to form a waterproof attachment.

15. The tuque of claim 10, wherein said water-proof, water-repellent, and thin sheet plastic/vinyl dome of said generally inverted cup-shaped dome of said dome has a stitched seam.

16. The tuque of claim 15, wherein said stitched seam of said water-proof, water-repellent, and thin sheet plastic/vinyl dome of said generally inverted cup-shaped dome of said dome maintains said generally circular peripheral flange of said water-proof, water-repellent, and thin sheet plastic/vinyl dome of said generally inverted cup-shaped dome of said dome affixed to said generally circular flange of said upper end of said water-proof, water-repellent, and thin sheet plastic/vinyl sleeve of said sleeve.

17. The tuque of claim 2, wherein said folded brim comprises said lower end of said water-proof, water-repellent, and thin sheet plastic/vinyl sleeve of said sleeve folded up outwardly onto itself.

18. The tuque of claim 2, wherein said folded brim of said lower end of said water-proof, water-repellent, and thin sheet plastic/vinyl sleeve of said sleeve is maintained folded up outwardly onto itself by seams.

19. The tuque of claim 18, wherein said seams of said folded brim of said lower end of said water-proof, water-repellent, and thin sheet plastic/vinyl sleeve of said sleeve are heated seams.

20. The tuque of claim 18, wherein said seams of said folded brim of said lower end of said water-proof, water-repellent, and thin sheet plastic/vinyl sleeve of said sleeve are stitched seams.

21. The tuque of claim 2, wherein said lower end of said water-proof, water-repellent, and thin sheet plastic/vinyl sleeve of said sleeve is folded up outwardly onto itself twice times so as to allow said decorative swim/bath/shower tuque to be in a long state, while said lower end of said water-proof, water-repellent, and thin sheet plastic/vinyl sleeve of said sleeve is folded up outwardly onto itself thrice times so as to allow said decorative swim/bath/shower tuque to be in a short state, to thereby allow said sleeve to have said dual lengths so as to adjust said sleeve to the length of the voluminous hair of the swimmer/bather/showerer.

22. The tuque of claim 2, wherein said folded brim comprises a drawstring.

23. The tuque of claim 22, wherein said drawstring of said folded brim extends along through said lower end of said water-proof, water-repellent, and thin sheet plastic/vinyl sleeve of said sleeve, and is pulled taunt after said decorative swim/bath/shower tuque has been donned to thereby replaceably maintain said decorative swim/bath/shower tuque in place on the swimmer/bather/showerer.

24. A method of making a decorative swim/bath/shower tuque for wearing by a swimmer/bather/showerer, respectively, having voluminous hair with a length, wherein the decorative swim/bath/shower tuque has dual lengths so as to adjust to the length of the voluminous hair of the swimmer/bather/showerer, said method comprising the steps of:
a) fabricating a sleeve with an upper end folded inward to form a generally circular flange and a lower end, and a dome having a generally circular peripheral flange;
b) closing the upper end of the sleeve using the dome;
c) positioning the generally circular peripheral flange of the dome inwardly and intimately adjacent to the generally circular flange of the upper end of the sleeve;
d) maintaining the generally circular peripheral flange of the dome affixed to the generally circular flange of the upper end of the sleeve by utilizing a seam so as to form a waterproof attachment;
e) positioning a drawstring along the lower end of the sleeve;
f) folding the lower end of the sleeve up outwardly onto itself so as to form a folded brim having the dual lengths and entrapping the drawstring; and
g) maintaining the folded brim folded by utilizing seams.

25. The method of claim 24, wherein said first maintaining step includes maintaining the generally circular peripheral flange of the dome affixed to the generally circular flange of the upper end of the sleeve by utilizing a heated seam so as to form a waterproof attachment.

26. The method of claim 24, wherein said first maintaining step includes maintaining the generally circular peripheral flange of the dome affixed to the generally circular flange of the upper end of the sleeve by utilizing a stitched seam so as to form a waterproof attachment.

27. The method of claim 24, wherein said second maintaining step includes maintaining the folded brim folded by utilizing heated seams.

28. The method of claim 24, wherein said second maintaining step includes maintaining the folded brim folded by utilizing stitched seams.

29. The method of claim 24, wherein the sleeve is a water-proof, water-repellent, and thin sheet plastic/vinyl sleeve.

30. The method of claim 29, wherein the water-proof, water-repellent, and thin sheet plastic/vinyl sleeve of the sleeve has a generally circular lateral cross section.

31. The method of claim 29, wherein the lower end of the water-proof, water-repellent, and thin sheet plastic/vinyl sleeve of the sleeve is open.

32. The method of claim 29, wherein the lower end of the water-proof, water-repellent, and thin sheet plastic/vinyl sleeve of the sleeve is foldable.

33. The method of claim 29, wherein the upper end of the water-proof, water-repellent, and thin sheet plastic/vinyl sleeve of the sleeve is open.

34. The method of claim 29, wherein the upper end of the water-proof, water-repellent, and thin sheet plastic/vinyl sleeve of the sleeve is folded inward to form the generally circular flange.

35. The method of claim 34, wherein the dome is a generally inverted cup-shaped dome.

36. The method of claim 35, wherein the generally inverted cup-shaped dome of the dome is a water-proof water-repellent, and thin sheet plastic/vinyl dome.

37. The method of claim 36, wherein the water-proof, water-repellent, and thin sheet plastic/vinyl dome of the generally inverted cup-shaped dome of the dome has a generally disk-shaped base.

38. The method of claim 37, wherein the generally circular peripheral flange of the water-proof, water-repellent, and thin sheet plastic/vinyl dome of the generally inverted cup-shaped dome of the dome depends from the generally disk-shaped base of said water-proof, water-repellent, and thin sheet plastic/vinyl dome of the generally inverted cup-shaped dome of the dome.

39. The method of claim 36, wherein the water-proof, water-repellent, and thin sheet plastic/vinyl dome of the generally inverted cup-shaped dome of the dome sits the upper end of the water-proof, water-repellent, and thin sheet plastic/vinyl sleeve of the sleeve; and
wherein the generally circular peripheral flange of the water-proof, water-repellent, and thin sheet plastic/vinyl dome of the generally inverted cup-shaped dome of the dome is inwardly and intimately adjacent to the generally circular flange of the upper end of the water-proof, water-repellent, and thin sheet plastic/vinyl sleeve of the sleeve.
